(19) United States
(12) Patent Application Publication
(10) Pub. No.: US 2007/0024414 A1
(43) Pub. Date: Feb. 1, 2007

(54) Sensing element with adsorptive layer and method of making the same

(76) Inventors: Richard F. Beckmeyer, Davisburg, MI (US); Eric P. Clyde, Bay City, MI (US); Jo-Ann S. Novak, Oxford, MI (US); William J. LaBarge, Bay City, MI (US); Bruce W. Holleboom, Grand Blanc, MI (US)

Correspondence Address: Jimmy L. Funke;Delphi Technologies, Inc., P.O. Box 5052, M/C 480-410-202, Troy, MI, 48007, US

(21) Appl. No.: 11/192,228

(22) Filed: Jul. 28, 2005

(51) Int. Cl. H01C 3/04; H01C 7/04; H01C 7/02

(52) U.S. Cl. 338/25

(57) ABSTRACT

A planar temperature sensing element is provided with first and second layers disposed over the temperature-sensing device. The second layer comprises an inorganic binder, a first ceramic material, and a second ceramic material. The inorganic binder is selected from the group consisting of M³⁺ phosphates, M⁴⁺ phosphates, M³⁺ nitrates, M⁴⁺ nitrates, and combinations comprising at least one of the foregoing. The first ceramic material is selected from the group consisting of aluminosilicate, M³⁺ aluminates, M⁴⁺ aluminates, M³⁺ hexaluminates, M⁴⁺ hexaluminates, and combinations comprising at least one of the foregoing. The second ceramic material comprises a phosphate-containing material.

### TECHNICAL FIELD

The present disclosure is related to a sensing element and a method of making the same and, more particularly, to a temperature-sensing element and a method of making the same.

### BACKGROUND

As environmental concerns and the demand for improved automobile fuel efficiency have increased, more stringent emission regulations have been implemented. The automobile industry has responded by developing improved exhaust treatment components. As a result, many vehicle exhaust systems typically comprise one or a variety of components designed to reduce undesirable emissions and/or to improve fuel efficiency, or to assist in the foregoing. Examples of such components comprise, but are not limited to, catalytic converters, catalytic absorbers, diesel particulate traps, non-thermal plasma conversion devices, and the like.

Typical vehicle exhaust environments may reach temperatures of about 1,000° C. Therefore, it is desirable that components used in an exhaust system environment are capable of withstanding such temperatures without physical destruction or performance degradation. Some exhaust treatment components or systems sometimes include temperature sensors that provide a signal related to the temperature of the exhaust system.

### SUMMARY

One embodiment is directed to a sensing element comprising a substrate having a surface, and a temperature-sensing device disposed on the substrate. The temperature-sensing device comprises a temperature-sensing element and two leads in electrical communication with the temperature-sensing element. A first layer is disposed over the temperature-sensing element and a portion of the leads. A second layer is disposed over the first layer. The second layer comprises an inorganic binder, a first ceramic material, and a second ceramic material. The inorganic binder is selected from the group consisting of M³⁺ phosphates, M⁴⁺ phosphates, M³⁺ nitrates, M⁴⁺ nitrates, and combinations comprising at least one of the foregoing. The first ceramic material is selected from the group consisting of aluminosilicate, M³⁺ aluminates, M⁴⁺ aluminates, M³⁺ hexaluminates, M⁴⁺ hexaluminates, and combinations comprising at least one of the foregoing. The second ceramic material comprises a phosphate-containing material.

Another embodiment is directed to a method of forming a sensing element. The method involves disposing a temperature sensing device on a substrate. The temperature-sensing device comprises a temperature-sensing element and leads in electrical communication with the temperature-sensing element. A first layer is disposed on the temperature sensing element and a portion of the leads. A second layer is disposed on the first layer. The second layer comprises an inorganic binder, a first ceramic material selected from the group consisting of aluminosilicate, M³⁺ aluminates, M⁴⁺ aluminates, M³⁺ hexaluminates, M⁴⁺ hexaluminates, and combinations comprising at least one of the foregoing, and a second ceramic material comprising a phosphate-containing material. The second layer is sintered to form the sensing element.

The above described and other features are exemplified by the following figures and detailed description.

### DRAWINGS

Refer now to the Figures, which are exemplary embodiments, and wherein like elements are numbered alike.

FIG. 1 is an exploded perspective view of a temperature sensing element with a poison trapping layer disposed over a protective cover.

FIG. 2 is a graphical representation of the resistance shift as a function of time for planar temperature sensors with and without a poison trapping layer.

### DETAILED DESCRIPTION

At the outset of the detailed description, it should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). Unless defined otherwise herein, all percentages herein mean weight percent (“wt. %”). Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). Finally, unless defined otherwise, technical and scientific terms used herein have the same meaning as is commonly understood by one of skill in the art to which this invention belongs. Unless specified otherwise, the term “diameter” refers to the average diameter of a agglomerate or agglomerate, as measured along its major axis.

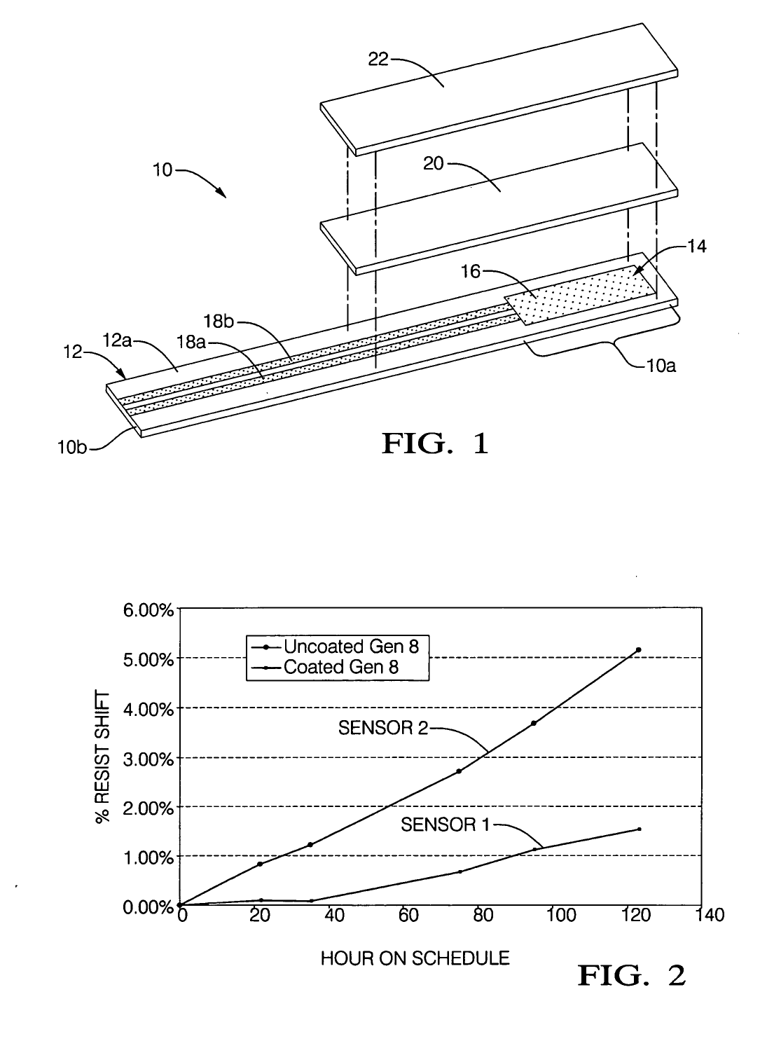

FIG. 1 shows a sensing element 10 comprising a ceramic substrate 12, a temperature sensor device 14 disposed over the ceramic substrate 12, a first layer 20 disposed over the temperature sensor device 14, and a second layer 22 disposed over the first layer 20. In the present embodiment, the substrate 12 has a generally rectangular shape and defines a sensing end 10a, a terminal end 10b, and an upper surface 12a.

The temperature sensor device 14 is disposed on the surface 12a of the substrate 12 and comprises a temperature-sensing element 16 disposed at the sensing end 10a and two temperature sensor leads 18a,b extending from the temperature-sensing element 16 toward the terminal end 10b of the substrate 12, which provide electrical communication to an external source (not illustrated). The temperature-sensing element 16 is illustrated herein as having a substantially rectangular pad, but it should be understood that it can comprise a variety of patterns or configurations. For example, the temperature-sensing element 16 can comprise a serpentine shape (e.g., comprising a plurality of spaced apart fingers), a rounded shape, and the like. The temperature-sensing element 16 can also be sized and dimensioned to comprise an exposed region of the substrate surface 12a surrounding it on all sides (e.g., about 0.5 millimeters (mm)), in order to accommodate an optional bonding material (not illustrated) that can be used to seal the protective layer 22 to the substrate 12, while still maintaining sufficient clearance to prevent contact between the temperature-sensing element 16 and the bonding material. By sealing the protective layer 22 to the substrate, the optional bonding material can provide an additional level of protection from contaminants. Suitable bonding materials include, but are not limited to, glass, and the like.

The sensor element 10 is sensitive to contaminants (also sometimes referred to as “poisons”) that can affect its performance. The temperature sensor device 14 is particularly sensitive to such contaminants, which can change its resistance characteristics. For example, engine exhaust can contain contaminants in gaskets, coolant, gasoline, engine oil, valve train metals, etc. Examples of such contaminants include, but are not limited to, M¹⁺ and M²⁺ metal cations, and the like. Examples of M¹⁺ and M²⁺ cations include, but are not limited to, sodium (Na¹⁺), potassium (K¹⁺), cesium (Cs¹⁺), barium (Ba²⁺), calcium (Ca²⁺), magnesium (Mg²⁺), strontium (Sr²⁺), zinc (Zn²⁺), iron (Fe²⁺), copper (Cu²⁺), cobalt (Co²⁺), lead (Pb²⁺), manganese (Mn²⁺), and the like, as well as metals that sometimes exist as +1 or +2 ions, e.g., lead (Pb), copper, (Cu), chrome (Cr), and zinc (Zn), and the like, and combinations comprising at least one of the foregoing. In order to prevent or minimize interference with the operation of the sensor 10, the substrate 12, temperature-sensing element 16, protective layer 20, and poison trapping layer 22 can comprise a combined concentration of less than 10 parts per million (ppm) of the contaminants, more particularly less than about 1 ppm.

The first layer 20 and the second layer 22 can be disposed over the substrate 12 and the temperature sensor device 14 in order to protect the temperature-sensing device 14 from such contaminants. For ease of explanation, the first layer 20 will be referred to hereinafter as the “protective layer 20,” and the second layer 22 will be referred to hereinafter as “the poison trapping layer 22.” The protective layer 20 and the poison trapping layer 22 can be disposed over the temperature sensor device 14 to cover the temperature sensing element 16 and optionally a portion of the leads 18a,b, thereby leaving a portion of the leads 18a,b uncovered, so as to allow electrical connection thereto. The protective layer 20 and the poison trapping layer 22 can be disposed over the temperature-sensing element 16 as conformal layers or, alternatively, formed separately and bonded to the substrate 12 or to the protective layer 20 using various methods such as, for example, glass sealing, and the like.

The substrate 12 can be any material capable of withstanding the operating temperatures in which the sensor will be processed and used. The substrate 12 can comprise a dielectric material comprising a resistance of greater than or equal to about 100,000 ohms at 1,000° C.; lower resistance values can cause the temperature sensor to report erroneous sensor outputs due to increased electronic noise.

Possible materials for the substrate 12 include, but are not limited to, aluminum oxide (Al₂O₃), aluminum nitride (AlN), boron nitride (BN), scandium oxide (Sc₂O₃), silicon oxide (SiO₂), silicon nitride (Si₃N₄), titanium oxide (TiO₂), zirconium oxide (ZrO₂), and combinations comprising at least one of the foregoing, as well as other dielectric materials. Additionally, the substrate 12 can comprise mixed oxides such as mullite (3Al₂O₃-2SiO₂), lanthanum aluminate (LaAlO₃), zirconium-aluminum oxide (ZrO₂—Al₂O₃), yttrium-zirconium-aluminum oxide (Y₂O₃—ZrO₂—Al₂O₃), fused silica (SiO₂), and the like.

Optionally, the substrate 12 can comprise a sintering aid such as a glass frit, provided it does not affect the resistance of the measuring electrode. Possible materials for the glass frit include, but are not limited to oxides of M⁺³ metals such as scandia (Sc₂O₃), yttria (Y₂O₃), lanthana (La₂O₃), ceria (CeO₂), boria (B₂O₃), and the like.

The substrate 12 can be formed by any suitable process such as, for example, die pressing, roll compaction, tape casting techniques, and the like. The substrate 12 can comprise a thickness sufficient to provide mechanical strength to the sensing element 10 and to support the sensing element material. For example, the substrate 12 can comprise a thickness of about 50 micrometers (μm) to about 2,000 μm; more particularly about 50 μm to about 800 μm; more particularly about 150 μm to about 450 μm; and still more particularly about 250 μm to about 350 μm.

The substrate 12 can be made from tape-cast layers that have been laminated at a temperature, pressure, and for a period of time sufficient to bond the various layers together and to eliminate any void spaces therebetween. For example, a pre-fired substrate can be isostatically laminated for about 1 minute to about 30 minutes, at temperatures of about 25° C. to about 125° C. and at pressures of about 400 pounds per square inch (psi) (about 2,758 kilopascal (kPa)) to about 4,500 psi (31,026 kPa). The substrate 12 can be fired to densification, that is, heated to a sufficient temperature and for a sufficient period of time to remove organics to less than about 1 wt. %, based on the total weight of the sintered substrate.

Suitable materials for the temperature-sensing device 14 can comprise any material capable of responding to a change in temperature, capable of withstanding subsequent processing conditions used in forming the sensing element 10, and capable of withstanding the operating conditions of the sensing element 10. The material can comprise a relatively high temperature coefficient of resistivity (TCR) value. The TCR is characterized by a change in resistance for each degree change of temperature over a given range, and is expressed in units of parts per million per degree Celsius (ppm/° C.). A positive TCR is characterized by an increase in resistance for each degree increase of temperature over a given range, and a negative TCR is characterized by a decrease in resistance for each degree increase over a given range. As the TCR increases, so does the change in resistance per degree temperature. The lower the TCR of the material, the smaller the change in resistance per degree temperature. The sensing element material can comprise a TCR of greater than or equal to about 800 parts per million per degree Celsius (ppm/° C.); more particularly greater than or equal to about 1,500 ppm/° C.; more particularly still greater than or equal to about 2,500 ppm/° C.; and still more particularly greater than or equal to about 3,000 ppm/° C.

The sensing element material also can comprise a relatively high natural resistivity (e.g., greater than or equal to about 5 micro-ohm-centimeters); can be stable at relatively high temperatures (for example, greater than or equal to about 600° C.); and can be stable over time at relatively high temperatures (for example, greater than or equal to about 100 hours at greater than or equal to about 950° C.).

Possible sensing element materials include, but are not limited to, metals and oxides of platinum, rhodium, palladium, iridium, ruthenium, gold, and mixtures and alloys comprising at least one of the foregoing materials. For example, the sensing element material can comprise platinum, which has a TCR of about 3,928 ppm/° C.

The sensing element material can be disposed on the substrate using various techniques, such as various thick and/or thin film techniques. For example, the sensing element material can be disposed on the substrate by thin film methods such as physical, chemical and/or thermal deposition techniques including sputtering, evaporation, physical vapor deposition, chemical vapor deposition, molecular beam epitaxy, laser-assisted, partially ionized beam deposition, and the like. Also for example, the sensing element material can be disposed on the substrate by thick film methods such as screen printing, plasma spraying, stenciling, dip coating, plating, and the like.

Suitable materials for the protective layer 20 comprise any material capable of withstanding high temperature environments (e.g., temperatures of greater than or equal to about 600° C.); capable of preventing contaminants from interfering with the operation of the sensing element 10 (e.g., being disposed in physical communication with the temperature-sensing element 16); and comprising a thermal expansion coefficient that is relatively close to that of the substrate 12 (e.g., within 0.5×10^{e-6} in/in/° C.).

Examples of suitable materials for the protective layer 20 include, but are not limited to, those materials discussed above in relation to the substrate 12, provided the material is sufficiently thermally conductive to allow heat to reach the temperature sensing element 16.

The protective layer 20 can be disposed over the temperature-sensing element 16 using various thick and/or thin film techniques including, but not limited to, those discussed above in connection with the temperature sensor device 14. The protective layer can comprise a thickness of, for example, about 150 μm to about 500 μm.

Suitable materials for the poison trapping layer 22 can comprise any material capable of “trapping” contaminants (e.g., by adsorption) as they migrate into and/or through the poison-trapping layer 22; capable of withstanding temperatures of about 1,300° C. with minimal or no shrinkage; capable of maintaining adhesion to underlying structures; capable of preventing contaminants from being disposed in physical communication with the temperature-sensing element 16; and comprising a thermal expansion coefficient that is relatively close to that of the substrate 12 (e.g., within 0.5×10^{e-6} in/in/° C.).

The poison trapping layer 22 comprises a first ceramic material, a second ceramic material, and an inorganic binder. Suitable materials for the first ceramic material are capable of withstanding temperatures of up to about 1,300° C. without undergoing any phase transformations (e.g., the material does not sinter at temperatures of less than or equal to about 1,300° C.); that are unreactive toward contaminants; that are not catalytically active; and that exhibit minimal or no shrinkage and/or volume loss at temperatures of less than or equal to about 1,300° C.; and that have a diameter of about ten times that of the second ceramic material. The poison trapping layer 22 can comprise about 88.0 wt. % to about 98 wt. % of first ceramic material, more particularly about 90 wt. % to about 96 wt. %, and more particularly still about 92 wt. % to about 94 wt. %, based on the total weight of the poison-trapping layer 22. The first ceramic material can comprise agglomerates of particles, in which the mean diameter of the agglomerates is greater than or equal to about 5.0 μm; more specifically greater than or equal to about 7.0 μm; and more specifically still greater than or equal to about 10.0 μm.

Examples of materials that can be used for the first ceramic material comprise, but are not limited to, trivalent metal ion (M³⁺) aluminates and hexaluminates, tetravalent metal ion (M⁴⁺) aluminates and hexaaluminates, and combinations comprising at least one of the foregoing. Examples of M³⁺ metal ions include, but are not limited to, La³⁺, Ce³⁺, Pr³⁺, Nd³⁺ Sm³⁺, Gd³⁺ and Sc³⁺, and the like. Examples of M³⁺ aluminates include, but are not limited to, lanthanum monoaluminate (LaAlO₃), cerium monoaluminate (CeAlO₃), neodymium monoaluminate (NdAlO₃), yttrium monoaluminate (YAlO₃), and the like, and mixtures and combinations comprising at least one of the foregoing. Examples of M³⁺ hexaaluminates include, but are not limited to, lanthanum hexaaluminate (LaAl₁₁O₁₉), lanthanum yttrium hexaaluminate (LaₓY₁₋ₓA₁₁O₁₉), lanthanum-neodymium hexaaluminate (LaₓNd₁₋ₓA₁₁O₁₉), lanthanum-praseodymium hexaaluminate (LaₓPr₁₋ₓA₁₁O₁₉), cerium hexaaluminate (CeAl₁₁O₁₉), lanthanum cerium hexaaluminate (LaₓCe₁₋ₓA₁₁O₁₉), and the like, and mixtures and combinations comprising at least one of the foregoing.

Suitable materials for the second ceramic material comprise any material that is highly reactive (e.g., highly adsorptive) toward contaminants, especially M¹⁺ and M²⁺ ions. The second ceramic material can comprise a surface area of greater than or equal to 130 meters-squared per gram (m²/gm), more specifically greater than or equal to about 200 m²/gm, and more specifically still greater than or equal to about 250 m²/gm. The second ceramic material can comprise agglomerates of particles, in which the mean diameter of the agglomerates is less than or equal to about 0.5 μm; more specifically less than or equal to about 0.3 μm; and more specifically still less than or equal to about 0.2 μm. Desirably, about 70 wt. % of the second ceramic material can comprise a pore diameter of about 20 Å to about 120 Å, based on the total weight of the second ceramic material.

The concentration of the second ceramic material can influence the effectiveness of the poison trapping layer 22. At concentrations below about 3.0 wt. %, the adherence of the poison trapping layer is reduced, making the layer susceptible to erosion; whereas concentrations greater than about 10.0 wt. % exceed the void volume of the first ceramic material, which can again disrupt the structure of the poison trapping layer 22. If and when the second ceramic material sinters and the second ceramic material exceeds about 10.0 wt. %, the poison trapping layer 22 can develop cracks, which may lead to eventual debonding of the entire poison trapping layer 22 from the underlying structure. The poison trapping layer 22 can comprise about 3.0 wt. % to about 10.0 wt. % of the second ceramic material, more particularly about 4.0 wt. % to about 7.0 wt. %, based on the total weight of the poison-trapping layer 22.

Examples of materials that can be utilized for the second ceramic material comprise phosphate-containing materials including, but not limited to, aluminophosphates (AlPO), silicophosphates (APSO), titanoaluminophosphate (TAPO), silicoaluminophosphates (SAPO) and the like, and combinations comprising at least one of the foregoing. Aluminophosphates (AlPOs) react with M²⁺ poisons to form metaloaluminophosphates sometimes known as MAPO's. The M²⁺ poisons can be found in automotive exhaust streams, and AlPOs will form, for example, compounds such as zinc-aluminophosphate (bonded through the anionic phosphate oxygen groups as P—O—Zn or P—O—Zn—O—P); iron-aluminophosphate (P—O—Fe—O—P); nickel-aluminophosphate (P—O—Ni—O—P); copper-aluminophosphate (P—O—Cu—O—P); manganese-aluminophosphate (P—O—Mn—O—P); and chromium-aluminophosphate (P—O—Cr—O—P). Other possible AlPOs include, but are not limited to, aluminophosphate molecular sieves such as AlPO-5, AlPO-8, AlPO-11, AlPO-18, AlPO-20, AlPO-31, AlPO-34, AlPO-36, AlPO-37, AlPO-39, AlPO-40, AlPO-46 or AlPO-47.

Suitable materials for the inorganic binder comprise those capable of binding the first and second materials together, and capable of binding the poison trapping layer 22 to the underlying support structures (e.g., to the protective layer 20 and/or the substrate 12), such as, but not limited to, trivalent (M³⁺) and/or tetravalent (M⁴⁺) metal ion phosphates, trivalent (M³⁺) and/or tetravalent (M⁴⁺) metal ion nitrates, and combinations comprising at least one of the foregoing. The poison trapping layer 22 can comprise about 2.4 wt % to about 7.2 wt % of the binder on a residual oxide basis.

Examples of trivalent and/or tetravalent metal ion phosphates include, but are not limited to, aluminum phosphate (Al³⁺), zirconium phosphate (Zr⁴⁺), and/or titanium phosphate (Ti⁴⁺), and combinations comprising at least one of the foregoing. Examples of trivalent and/or tetravalent metal ion nitrates include, but are not limited to, aluminum nitrate, zirconium nitrate, and/or titanium nitrate, and combinations comprising at least one of the foregoing.

Examples of binder sources comprise a mixture of an aluminum source (such as pseudoboehmite, alumina sol, aluminum hydroxide, aluminum isopropoxide, aluminum triethoxide, and the like, as well as combinations comprising at least one of the foregoing) and a phosphate source (such as phosphoric acid and/or triethyl phosphate, and the like, as well as combinations comprising at least one of the foregoing). The final ratio of Al₂O₃ to P₂O₅ can be less than 1.0, more particularly less than 0.8, and more particularly still less than 0.6.

Not to be bound by any theory, it is believed that upon sintering, the first ceramic material (i.e., with the larger diameter) provides a relatively coarse matrix containing voids that become occupied with the second ceramic material (i.e., with the smaller agglomerates), which greatly increasing the number of contacts between the agglomerates, thereby increasing erosion resistance of the poison-trapping layer. If the sensor temperature reaches over about 1,100° C., the first ceramic material will not sinter. Because the first ceramic layer defines the structure of the poison trapping layer 22, at least in part, if matrix formed by the first ceramic material does not shrink, then the poison trapping layer 22 will not shrink. Thus, the first ceramic material provides stability to the layer by preventing or minimizing debonding of the poison trapping layer from underlying structures.

Again not to be bound by any theory, it is believed that the smaller agglomerates of the second ceramic material fill the voids between and/or coat the larger agglomerates of the first ceramic material (e.g., packing into the voids between the larger agglomerates). The M¹⁺ and M²⁺ poisons by-pass the larger agglomerates, which are inactive for M¹⁺ and M²⁺ adsorption and come into contact with and are trapped by (i.e., adsorbed by) the very active small agglomerates. Thus, it is believed that the presence of the smaller agglomerates of the second ceramic material filling the voids and/or coating the larger agglomerates can minimize or prevent aggregation of the larger agglomerates, which can occur at elevated temperatures. The formation of larger agglomerates tends to increase the likelihood of cracks forming in the poison trapping layer 22, which would allow migration of contaminants therethrough.

It is desirable for the surface area of the first and second ceramic materials to remain greater than or equal to about 100 m²/gm at temperatures of greater than or equal to about 900° C., which can occur in exhaust systems. If the sensor temperature reaches greater than or equal to about 1,100° C., the second ceramic material can sinter, causing a decrease in its surface area (e.g., to about 8 m²/gm to about 30 m²/gm).

Optionally, the poison-trapping layer 22 can comprise about 3.4 wt. % to about 7.2 wt. % of a stabilizing material, based on the total combined weight of the ceramic materials and stabilizer. Suitable stabilizing materials can comprise barium, cerium, lanthanum, oxides of the foregoing, compounds of the foregoing, and combinations comprising at least one of the foregoing. Other suitable stabilizing materials comprise zirconates, titanates, oxides of the foregoing, compounds of the foregoing, and combinations comprising at least one of the foregoing. For example, when aluminophosphate is used for the first ceramic material and lanthanum monoaluminate is used for the second ceramic material, it has been found suitable to use zirconia as a stabilizer to inhibit reaction between the aluminophosphate and lanthanum-aluminate phases.

Optionally, the poison-trapping layer 22 optionally can comprise about 0.4 wt % to about 2.8 wt % of a fugitive material, based on the total weight of the poison-trapping layer 22, prior to firing. The fugitive material can be selected from the group comprising carbon black, graphite, insoluble organics, and combinations comprising at least one of the foregoing.

Optionally, the poison-trapping layer 22 optionally can comprise less than or equal to about 4.7 wt. % of an additional scavenger material. The additional scavenger material can comprise an M⁵⁺ or M⁶⁺ transition metal oxide such as WO₃, MoO₃ or Nb₂O₅. The additional scavenger materials are capable of forming complex oxides (e.g., Na₂WO₄ and/or Na₂MoO₄, and the like) with M¹⁺ metals. The additional scavenger material can comprise a surface area of greater than or equal to about 10 m²/gm, more particularly greater than or equal to about 30 m²/gm after dynamometer testing of the sensor in an exhaust gas at a temperature of about 1,000° C., which simulates the average design life of a temperature sensor in an actual vehicle driven over 120,000 miles.

The poison-trapping layer 22 can be disposed over the protective layer 20 using various thick and/or thin film techniques including, but not limited to, those discussed above in connection with the temperature sensor device 14 and protective layer 20. For example, a slurry can be formed by adding the first ceramic material, the second ceramic material and the binder to a solvent, as well as any optional stabilizer, fugitive material and/or scavenger material. The slurry can be disposed over the protective layer 20, for example, by spraying/dipping or the like to obtain a wet coating of the slurry on the sensor. The sensor element coated with the wet slurry can be heated to a sufficient temperature to dry the slurry (e.g., for about 10 minutes at about 60° C.). The sensor coated with the dried slurry can then be heated to a sufficient temperature (e.g., at least about 430° C., more particularly about 750° C. to about 1,000° C.) and for a sufficient period of time (e.g., about 2 hours) to calcine the ceramic materials in the slurry. The resulting calcined poison-trapping layer 22 can comprise a relatively low porosity (e.g., about 20-35 vol. %), relatively dense layer (e.g., about 2.8 grams per cubic centimeter (g/cm³)), having a thickness of, for example, about 125 μm to about 300 μm.

In addition, the substrate and layers are shown as being in direct contact with one another, but it should be understood that the disclosure is not restricted to such an arrangement, and other materials or layers can be disposed between or over any of the layers provided such materials do not interfere with the manufacture or operation of the sensor 20.

The following non-limiting examples further illustrate the various embodiments described herein.

### WORKING EXAMPLES

### Example I

### Base Formulation

A slurry was prepared by combining 812 grams of lanthanum monoaluminate (LaAlO₃), 560 grams of alpha aluminum oxide (Al₂O₃), 32 grams of zirconium oxyacetate (19% solids when calcined), 67 grams of aluminum nitrate nonahydrate and 1,270 grams distilled water. The lanthanum monoaluminate agglomerates ranged in size from 5 μm to 25 μm and the alpha aluminum oxide agglomerates ranged in size from 0.1 μm to 0.3 μm.

The slurry was high shear mixed for about 25 minutes. About 70 grams of amorphous carbon was added to the slurry. The slurry was high shear mixed for 14 minutes.

A temperature sensor (Sensor 1) comprising a substrate, a resistive element, a protective coating and a glass sealant disposed between the substrate and the protective coating was dipped into the resulting slurry and withdrawn, leaving a wet deposit of slurry on the sensor having a weight of about 248 milligrams (mg). The sensor was then heated for about 10 minutes at about 60° C. to dry the slurry, and then heated for about 2 hours at a temperature of about 430° C. to calcine the dried slurry, thereby forming the poison trapping layer. The resulting poison trapping layer had a weight of between about 112 mg.

Sensor 1 was compared to a second temperature sensor (Sensor 2) having the same structure as Sensor 1 with the exception of the poison trapping layer. An accelerated dynamometer engine test was run, in which each 50 hours of the test simulated about 125,000 miles of vehicle operation. More particularly, oil was directly injected into the exhaust stream, wherein the oil in the exhaust stream comprised 10 times the M⁺¹ and M⁺² detergent components ordinarily present in an exhaust stream. The temperature sensor was placed in fluid communication with the exhaust stream.

FIG. 2 is a graphical representation of the resistance shift as a function of time for the two sensors, in which each 50 hours simulated about 125,000 miles of vehicle operation. It is noted that there was essentially no resistance shift up to about thirty-five (35) hours of testing for Sensor 1, whereas Sensor 1 exhibited a substantially linear increase in resistance during the same time period. Because fifty (50) hours of dynamometer testing represented the average design life of a temperature sensor, the Sensor 1 (comprising the poison trapping layer) outperformed Sensor 2 (without the poison trapping layer), having a percent resistance shift of less than or equal to about 1.00%, more specifically less than or equal to about 0.50%, while Sensor 2 has a percent resistance shift of >1.50%, and even greater than 1.75%. This trend was maintained for the duration of the test, in which Sensor 1 exhibited a smaller increase in % resistance shift at 100 hours than Sensor 2 showed at 50 hours. More particularly, Sensor 1 had a % resistance shift of less than 2.0% after 120 hours of dynamometer testing (about 300,000 miles of vehicle operation), whereas Sensor 1 had a % resistance shift of greater than 5%.

Without being bound by theory, a percent resistance shift can be attributed to M⁺¹ and M⁺² contaminant migration to the resistive element. As such, Sensor 1 had less M⁺¹ and M⁺² contaminant migration in comparison the Sensor 1.

### Example II

### AlPO as Second Ceramic

A slurry was prepared by adding 812 grams of lanthanum monoaluminate (LaAlO₃), 560 grams of molecular sieve AlPO₄-34, 32 grams of zirconium oxyacetate (19% solids when calcined), 67 grams of aluminum nitrate nonahydrate and 1,270 grams of distilled water. The lanthanum monoaluminate agglomerates had a diameter of about 5 μm to about 25 μm and the alpha aluminum oxide agglomerates had a diamter of about 0.1 μm to about 0.3 μm.

After forming the slurry, the same procedure used in Example 1 was followed. The resulting poison trapping layer had a weight of about 178 mg.

### Example III

### Aluminum Phosphate Binder

A slurry was prepared by adding 812 grams lanthanum stabilized aluminate, 560 grams aluminophosphate molecular sieve AlPO₄-34, 89 grams of pseudoboehmite (aluminum hydroxide, average formula Al₄O₃(OH)₆), 147 grams of 85% H₃PO₄ solution, and 1,146 grams distilled water. The lanthanum stabilized aluminate agglomerates had a diameter of about 3 μm to about 18 μm, and the AlPO₄-34 agglomerates had a diameter of about 0.1 μm to about 0.3 μm.

The slurry was high shear mixed for about 25 minutes. The slurry viscosity dropped as the shear rate increased. The resulting slurry was applied to sensors using an automated dipping machine. Sensors were dipped into the slurry and withdrawn, leaving a wet deposit of slurry on the sensor having a weight of about 140 mg. The sensor coated with the wet slurry was then heated for about 12 hours at about 175° C. to faciliate crystallization of the aluminum phosphate. The sensor with the dried slurry was then heated in air for about 2 hours at a temperature of about 925° C. to calcine the dried slurry, thereby forming the poison trapping layer. The resulting poison trapping layer had a weight of between about 70 mg.

### Example IV

### Lanthanum Hexaaluminate

A slurry was prepared by adding 1008 grams lanthanum hexaaluminate, 198 grams of pseudoboehmite (aluminum hydroxide, average formula Al₄O₃(OH)₆), 442 grams of 85% H₃PO₄ solution (Al₂O₃/P₂O₅=0.8) and 1,038 grams distilled water. The lanthanum hexaaluminate agglomerates had a diameter of about 2 μm to about 11 μm.

The slurry was high shear mixed for about 25 minutes. The sensors were dipped into the slurry and withdrawn, leaving a wet deposit of slurry on the sensor having a weight of about 120 mg to about 280 mg [Bill, what was actual weight?]. The sensor coated with the wet slurry was then heated for about 2 hours at about 110° C. to dry the slurry, and then heated in air for about 2 hours at a temperature of about 925° C. to calcine the dried slurry, thereby forming the poison trapping layer. The resulting poison trapping layer had a weight of between about 95 mg and about 150 mg.

The poison-trapping layer of the present disclosure can provide: 1) increased protection from contaminants with a small loss of response time; 2) can provide a relatively dense, low porosity layer with relatively high surface area that adsorbs more contaminants than sensors with only a protective layer; 3) can provide improved adhesion to underlying structures such as the protective layer and the substrate; 4) can provide a layer of protection that has a thermal expansion rate well matched to that of the substrate to prevent, for example, cracking of the layer; 5) can minimize or prevents phase transformations between room temperature and operating temperature, which prevents cracking of the protective layer; and 6) can increase the durability of the sensor by preventing sintering of the protective layer while the sensor is in use on a vehicle.

While the disclosure has been described with reference to an exemplary embodiment, it will be understood by those skilled in the art that various changes can be made and equivalents can be substituted for elements thereof without departing from the scope of the disclosure. In addition, many modifications can be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A sensing element comprising:
a substrate having a surface;
a temperature-sensing device disposed on the substrate, the temperature-sensing device comprising a temperature-sensing element and two leads in electrical communication with the temperature-sensing element;
a first layer [20] disposed over the temperature-sensing element and a portion of the leads; and
a second layer disposed over the first layer, the second layer comprising an inorganic binder, a first ceramic material, and a second ceramic material, wherein the inorganic binder is selected from the group consisting of M³⁺ phosphates, M⁴⁺ phosphates, M³⁺ nitrates, M⁴⁺ nitrates, and combinations comprising at least one of the foregoing, the first ceramic material is selected from the group consisting of aluminosilicate, M³⁺ aluminates, M⁴⁺ aluminates, M³⁺ hexaluminates, M⁴⁺ hexaluminates, and combinations comprising at least one of the foregoing, and the second ceramic material comprises a phosphate-containing material.

2. The sensing element of claim 1, wherein the second layer comprises about 88 wt. % to about 98 wt. % of the first ceramic material, and about 3 wt. % to about 10 wt. % of the second ceramic material, based on the total weight of the second layer.

3. The sensing element of claim 2, wherein the second layer comprises about 2.4 wt. % to about 7.2 wt. % of the inorganic binder, based on the total weight of the second layer.

4. The sensing element of claim 1, wherein greater than or equal to about 70 wt. % of the second ceramic material comprises a pore diameter of about 20 Å to about 120 Å, based on the total weight of the second ceramic material.

5. The sensing element of claim 1, wherein the first ceramic material comprises agglomerates having a mean diameter of greater than or equal to about 5 μm and the second ceramic material comprises agglomerates having a mean diameter of less than or equal to about 0.5 μm.

6. The sensing element of claim 1, wherein the phosphate-containing second ceramic material is selected from the group consisting of aluminophosphates (APO), silicophosphates (APSO), titanoaluminophosphate (TAPO), silicoaluminophosphates (SAPO), and combinations comprising at least one of the foregoing.

7. A method of forming a sensing element, comprising:
disposing a temperature sensing device on a substrate, the temperature-sensing device comprising a temperature-sensing element and leads in electrical communication with the temperature-sensing element;
disposing a first layer on the temperature sensing element and a portion of the leads;
disposing a second layer on the first layer, the second layer comprising an inorganic binder, a first ceramic material selected from the group consisting of aluminosilicate, M³⁺ aluminates, M⁴⁺ aluminates, M³⁺ hexaluminates, M⁴⁺ hexaluminates, and combinations comprising at least one of the foregoing, and a second ceramic material comprising a phosphate-containing material; and
sintering the second layer to form the sensing element.

8. The method of claim 7, wherein the second layer comprises about 88 wt. % to about 98 wt. % of the first ceramic material, and about 3 wt. % to about 10 wt. % of the second ceramic material, based on the total weight of the second layer.

9. The method of claim 7, wherein the second layer comprises about 2.4 wt. % to about 7.2 wt. % of the inorganic binder, based on the total weight of the second layer.

10. The method of claim 7, wherein greater than or equal to about 70 wt. % of the second ceramic material comprises a pore diameter of about 20 Å to about 120 Å, based on the total weight of the second ceramic material.

11. The method of claim 7, wherein the first ceramic material comprises agglomerates having a mean diameter of greater than or equal to about 5 μm and the second ceramic material comprises agglomerates having a mean diameter of less than or equal to about 0.5 μm.

12. The method of claim 7, wherein the phosphate-containing second ceramic material is selected from the group consisting of aluminophosphates (APO), silicophosphates (APSO), titanoaluminophosphate (TAPO), silicoaluminophosphates (SAPO), and combinations comprising at least one of the foregoing.
